(19) United States
(12) Patent Application Publication
(10) Pub. No.: US 2014/0372179 A1
(43) Pub. Date: Dec. 18, 2014

(54) REAL-TIME SOCIAL ANALYSIS FOR MULTIMEDIA CONTENT SERVICE

(71) Applicant: KT CORPORATION, Gyeonggi-do (KR)

(72) Inventors: Dae-Wu JU, Seoul (KR); Kun-Tae KIM, Gyeonggi-do (KR); Jeong-Kuk KIM, Seoul (KR); Sang-Mok PARK, Gyeonggi-do (KR); Jong-Bin LEE, Seoul (KR)

(73) Assignee: KT CORPORATION

(21) Appl. No.: 14/302,216

(22) Filed: Jun. 11, 2014

(30) Foreign Application Priority Data
Jun. 13, 2013 (KR) 10-2013-0067532

(51) Int. Cl. G06Q 50/00; G06Q 30/02

(52) U.S. Cl. CPC G06Q 50/01; G06Q 30/0201
USPC 705/7.33

(57) ABSTRACT

The disclosure is related to a real-time analysis of social network service (SNS) data associated with a multimedia content service. Particularly, SNS users may be classified into active SNS users and non-active SNS users, based on an SNS activity amount. SNS data collection/analysis periods may be differently determined according to SNS user types. Furthermore, a statistical analysis result of the SNS data may be directly or indirectly provided to one or more user equipment such that the SNS data analysis result can be displayed along with a corresponding multimedia content.

### CROSS REFERENCE TO PRIOR APPLICATIONS

The present application claims priority under 35 U.S.C. §119 to Korean Patent Application No. 10-2013-0067532 (filed on Jun. 13, 2013), which is hereby incorporated herein by reference in its entirety.

### TECHNICAL FIELD

The present disclosure relates to a social network service (SNS) and, in particular, to a real-time analysis of SNS data associated with a multimedia content service.

### BACKGROUND

A variety of social network services (SNS) such as Facebook, Twitter, and/or Kakao Talk are being widely used to form human networks (social networks) between users on the web. The social network service (SNS) may enable users to rapidly share ideas, pictures, posts, activities, events, interests, and living information with people in their network

Social analytics is a technique which quickly analyzes a large amount of messages created in the SNS. The social analytics may analyze words expressing emotion of human beings, by using a text analysis scheme. More specifically, the social analytics may determine whether an emotional word is related to a positive response or a negative response according to the context. Typically, such social analytic technique is being used in the field of brand identity and management, in order to analyze the image (e.g., public image) and preference associated with a specific enterprise or person in an SNS. Furthermore, the social analytic technique is also used in the field of customer services for gathering and managing the opinions of customers.

However, in case of such typical social analytic technique, one or more days might be required to collect SNS data, analyze the collected SNS data, and report an analysis result due to a large calculation burden of data processing. Accordingly, multimedia content providers and/or users may not quickly grasp users' responses or public opinions. For this reason, a typical social analytic technique may be difficult to apply to a variety of fields (e.g., a live broadcast service) requiring a real-time analysis. Furthermore, in order to provide in real-time a variety of user responses and/or vitalize a multimedia content service, a statistical analysis of SNS data associated with the multimedia content service may be required.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, social network service (SNS) data may be analyzed in real-time. In particular, social network service (SNS) data associated with a multimedia content providing service (e.g., a live broadcast service) may be analyzed in real-time. More specifically, SNS users may be classified into active SNS users and non-active SNS users, based on an SNS activity amount. In this case, SNS data collection periods may be differently determined between the active SNS users and the non-active SNS users. Furthermore, such SNS data analysis result may be directly or indirectly provided to one or more user equipment, along with a corresponding multimedia content.

In accordance with at least one embodiment, a method may be provided for performing a social analysis for a multimedia content service. The method may include classifying social network service (SNS) users into active SNS users and non-active SNS users based on an SNS activity amount; collecting SNS data created by the active SNS users in a preset analysis time range; and creating SNS analysis information associated with a specific multimedia content by analyzing the collected SNS data.

The method may further include transmitting the SNS analysis information to at least one of a corresponding content providing server and one or more corresponding user equipment.

The active SNS users and non-active SNS users may be classified based on whether the number of SNS use is greater than or equal to one within one week.

The collecting may include collecting the SNS data created by the active SNS users, at a first time interval.

The method may further include collecting SNS data created by the non-active users, at a second time interval, wherein the second time interval is longer than the first time interval.

The preset analysis time range may be a time range from a broadcast start time to a broadcast end time, in a case that the specific multimedia content is a live broadcast content. The first time interval may be determined in a unit of minutes, and the second time interval may be determined in a unit of hours or days.

The creating may include extracting SNS data including one or more keywords associated with a specific multimedia content, from the collected SNS data; and creating the SNS analysis information by analyzing attributes of the extracted SNS data.

The one or more keywords may be received from a corresponding content providing server.

The SNS analysis information may include at least one of (i) an SNS data amount per time slot, (ii) a proportion of positive/negative responses, (iii) a proportion of posted/re-posted SNS data, and (iv) one or more related keywords.

The SNS analysis information may include statistical information expressed using one or more visual expression means.

The SNS analysis information may be mapped to the collected SNS data.

The SNS analysis information may include a first layout including one or more icons and basic SNS analysis information to be provided through the one or more icons; and a second layout including detailed SNS analysis information and corresponding SNS data. Herein, the second layout may be provided in response to a user request.

In a case that the specific multimedia content includes a plurality of themes, the one or more keywords associated with the specific multimedia content may be separately determined per each theme of the specific multimedia content.

In accordance with other embodiments, a method may provide social network service (SNS) analysis information in a content providing server. The method may include transmitting one or more keywords associated with a multimedia content, to a social analysis system; providing a multimedia content service to one or more user equipment; receiving the SNS analysis information from the social analysis system; and providing the SNS data information to the one or more user equipment.

The social analysis system may be configured to classify SNS users into active SNS users and non-active SNS users based on an SNS activity amount; to receive the one or more keywords from the content providing server; to collect SNS data created by the active SNS user; to extract SNS data including the one or more keywords, from the collected SNS data; to create the SNS analysis information associated with the multimedia content by analyzing the extracted SNS data; and to transmit the SNS analysis information to the content providing server.

The social analysis system may be configured to collect the SNS data created by the active SNS users, at a first time interval; and to collect SNS data created by the non-active users, at a second time interval being longer than the first time interval.

The first time interval may be determined in a unit of minutes, and the second time interval may be determined in a unit of hours or days.

The multimedia content service may be a live broadcast service, and, the SNS data information may be provided along with the live broadcast service.

In accordance with still other embodiments, a method may be provided for displaying social network service (SNS) analysis information in user equipment. The method may include receiving a multimedia content from a content providing server; receiving the SNS analysis information associated with the multimedia content, from at least one of the content providing server and a social analysis system; and displaying the multimedia content and the SNS analysis information. Herein, the SNS analysis information may include a first layout including one or more icons and basic SNS analysis information provided through the one or more icons; and a second layout including detailed SNS analysis information and corresponding SNS data, wherein the second layout is displayed according to a user selection.

The multimedia content may be a live broadcast content, and the SNS analysis information may include statistical information expressed using one or more visual expression means.

### BRIEF DESCRIPTION OF THE DRAWINGS

The above and/or other aspects of some embodiments of the present invention will become apparent and more readily appreciated from the following description of embodiments, taken in conjunction with the accompanying drawings, of which:

FIG. 1A and FIG. 1B illustrate interworking between systems for a real-time social analysis for a multimedia content service in accordance with at least one embodiment;

FIG. 2 is a block diagram illustrating a detailed structure of a social analysis system in accordance with at least one embodiment;

FIG. 3 is a block diagram illustrating a detailed structure of user equipment in accordance with at least one embodiment;

FIG. 4 and FIG. 5 illustrate methods of performing a real-time social analysis for a multimedia content service in accordance with at least one embodiment;

FIG. 6A and FIG. 6B illustrate other methods of performing a real-time social analysis for a multimedia content service in accordance with other embodiments;

FIG. 7 illustrates first layouts associated with basic SNS analysis information in accordance with at least one embodiment; and

FIG. 8A through FIG. 8D illustrate second layouts associated with detailed SNS analysis information in accordance with at least one embodiment.

### DETAILED DESCRIPTION OF EMBODIMENTS

Reference will now be made in detail to exemplary embodiments of the present invention, examples of which are illustrated in the accompanying drawings, wherein like reference numerals refer to like elements throughout. The embodiments are described below, in order to explain embodiments of the present invention by referring to the figures.

The present embodiment may analyze social network service (SNS) data in real-time. In particular, the present embodiment may analyze in real-time social network service (SNS) data associated with a multimedia content providing service (e.g., a live broadcast service). More specifically, SNS users may be classified into active SNS users and non-active SNS users, based on an SNS activity amount. In this case, SNS data collection periods may be differently determined between the active SNS users and the non-active SNS users. Furthermore, such SNS data analysis result may be directly or indirectly provided to one or more user equipment, along with a corresponding multimedia content.

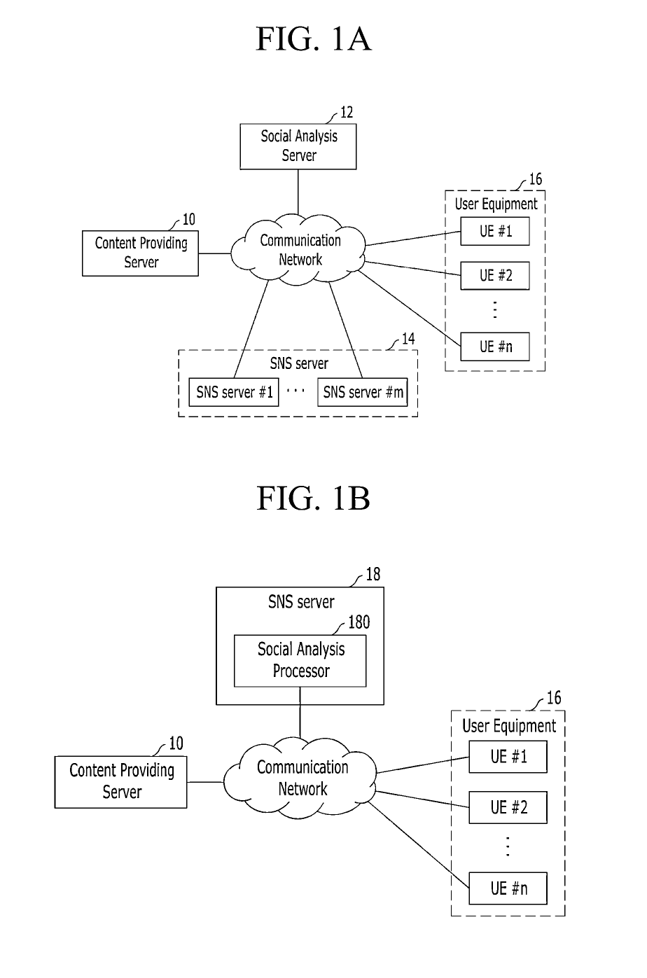

FIG. 1A and FIG. 1B illustrate interworking between systems for a real-time social analysis for a multimedia content service in accordance with at least one embodiment. Social analysis procedure (i.e., an analysis procedure of SNS data) may be performed (i) in a separate server such as social analysis server 12, as shown in FIG. 1A, or (ii) in SNS server 18 including social analysis processor 180, as shown in FIG. 1B.

Referring to FIG. 1A, content providing server 10, social analysis server 12, one or more SNS servers 14, and one or more user equipment 16 may be connected to and communicate with each other through communication networks. Herein, the communication network may include a variety of wired/wireless networks such as Internet, a local area network (LAN), a wireless local area network (wireless LAN), a wide area network (WAN), a personal area network (PAN), or the like. However, an exemplary embodiment is not limited thereto, and the communication network may be any wired/wireless network capable of transmitting and receiving information or data.

Content providing sever 10 may provide multimedia contents (e.g., a live broadcast content) to one or more user equipment 16 (e.g., UE #1, UE#2, . . . , UE #n). In at least one embodiment, content providing sever 10 may provide the multimedia contents to one or more user equipment 16, according to a request of the one or more user equipment 16. Herein, content providing sever 10 may include a content streaming server, a broadcasting server, a media server, a broadcast headend, or the like. However, an exemplary embodiment is not limited thereto, and content providing sever 10 may be any server capable of providing multimedia contents (e.g., broadcast contents). The multimedia content may include a variety of contents such as a drama, news, a movie, sports, entertainments, a game, music, an education program, or the like. Furthermore, content providing sever 10 may provide one or more keywords associated with a corresponding multimedia content, to social analysis server 12. More specifically, the one or more keywords (e.g., “North Korea”) may be associated with a theme (e.g., North Korea's nuclear test) of the multimedia content (e.g., a live debate program). In the case that a multimedia content includes a plurality of themes (e.g., “North Korea's nuclear test,” and “school without violence”), keywords may be determined and transmitted per theme. In at least one embodiment, content providing sever 10 may receive SNS analysis result (SNS analysis information) from social analysis sever 12. In this case, content providing sever 10 may provide the received SNS analysis result (SNS analysis information) and/or a corresponding multimedia content (e.g., a corresponding broadcast content portion in case of a live broadcast program). In other embodiments, content providing sever 10 may update a multimedia content, based on the received SNS analysis result. Furthermore, content providing sever 10 may change or modify a theme associated with a corresponding multimedia content, based on the received SNS analysis result.

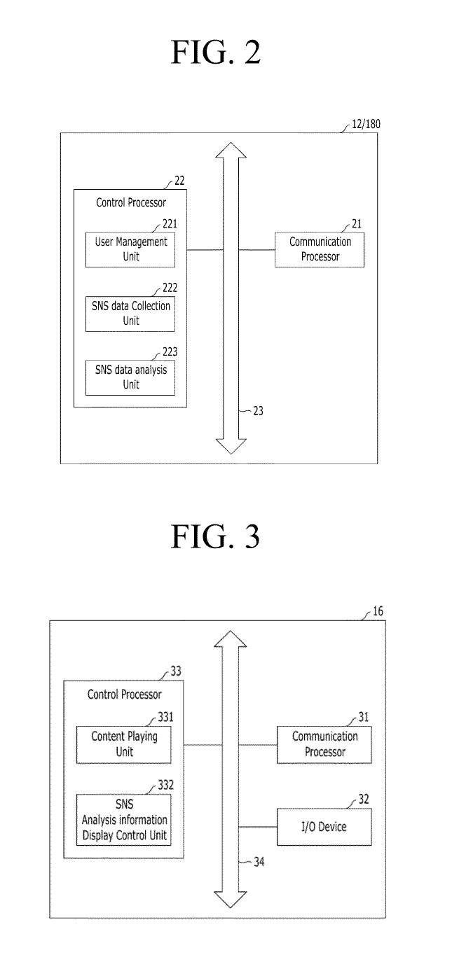

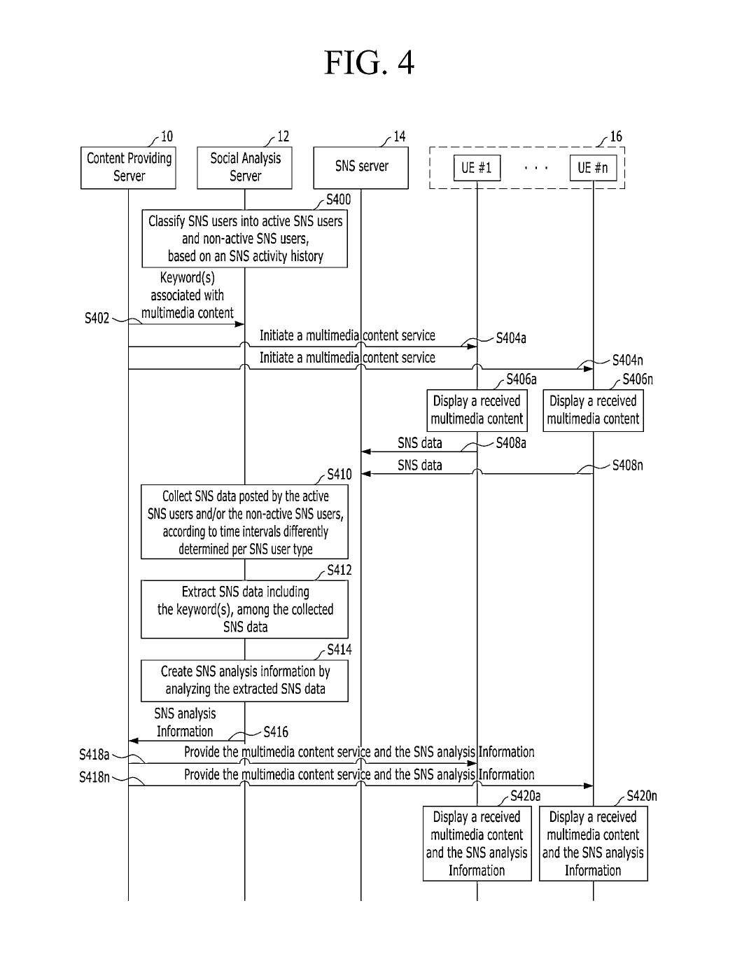

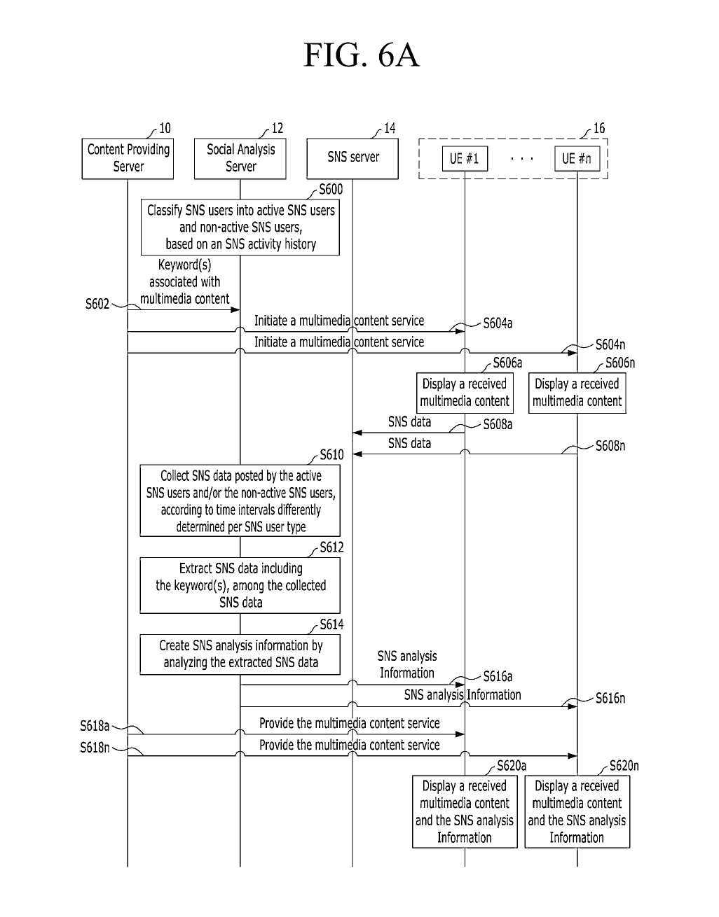

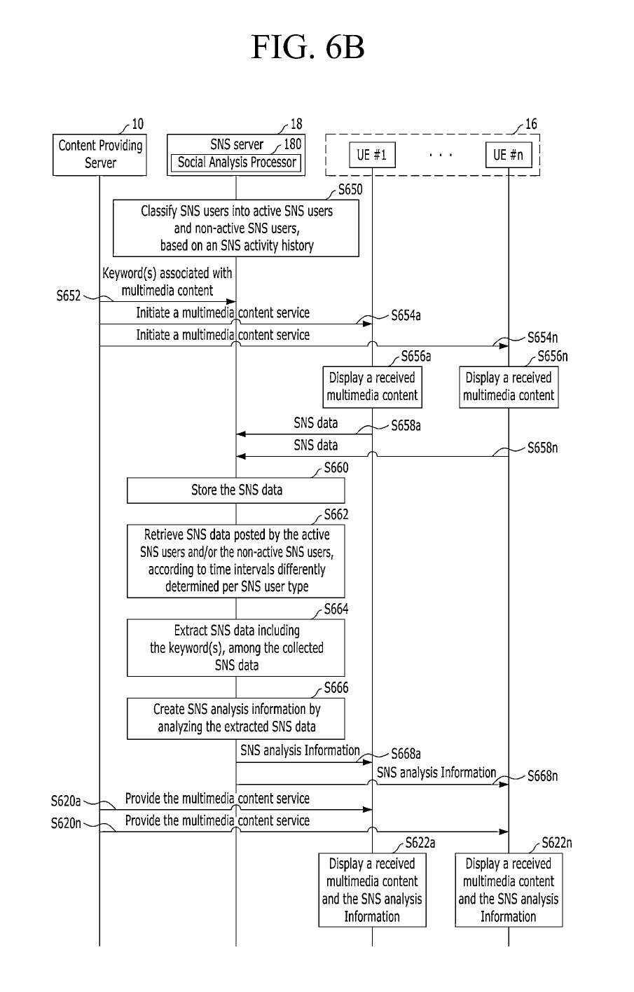

Social analysis sever 12 according to the present embodiment may (i) collect SNS data (e.g., SNS messages) from one or more SNS servers 14, (ii) analyze the collected SNS messages, and (iii) provide an SNS analysis result to content providing server 10. Herein, the SNS data may be any message, data, or information which is sent, exchanged, or shared in connection with an SNS. With respect to an SNS analysis procedure, SNS users may be classified into active SNS users and non-active SNS users, based on an SNS activity amount. In this case, SNS data collection/analysis periods may be differently determined between the active SNS users and the non-active SNS users. In other embodiments, social analysis sever 12 may directly provide an SNS analysis result to user equipment 16. Such SNS analysis procedure of social analysis sever 12 will be described in more detail with reference to FIG. 2, FIG. 4, and FIG. 6 to FIG. 8D.

One or more SNS servers 14 (e.g., SNS server #1, SNS server #2, . . . , SNS server #m) may provide a social network service (SNS) which forms human networks (social networks) between users on the web. More specifically, one or more SNS servers 14 may enable users to rapidly share ideas, pictures, posts, activities, events, interests, and living information with people in their network. For example, one or more SNS servers 14 may be any server capable of providing such SNS as Facebook, Twitter, Google+, blogging, or the like, but is not limited thereto. When receiving SNS data from one or more user equipment 16, one or more SNS severs 16 may store and manage the received SNS data. The SNS data stored in one or more SNS severs 16 may be collected by SNS analysis server 12.

One or more user equipment 16 may receive a variety of multimedia contents and/or an SNS analysis result from content providing sever 10, and send (e.g., post) SNS data (e.g., SNS messages) to one or more SNS servers 14. For example, in case of a live broadcast, users may watch the live broadcast through their user equipment 16, and post SNS messages associated with a theme of the live broadcast, to one or more SNS servers 14. Herein, the user equipment 16 may include a variety of television devices such as an internet protocol television (IPTV), a smart TV, connected TV, a connected TV, or the like. Furthermore, the user equipment 16 may be a variety of portable computing devices such as a laptop computer, a tablet computer, a netbook computer, a ultra-book computer, a sub-notebook computer, a desknote computer, a ultra-mobile PC (UMPC), a smart pad, or the like. The user equipment 16 may be a variety of communication terminals such as a personal communication system (PCS), a ‘global system for mobile communications’ (GSM) terminal, a personal digital cellular (PDC) terminal, a personal handyphone system (PHS), a personal digital assistant (PDA), an international mobile telecommunication (IMT)-2000 terminal, a code division multiple access (CDMA)-2000 terminal, a W-CDMA terminal, a wireless broadband internet (Wibro) terminal, a smart phone, or the like. The embodiments are not limited in this context.

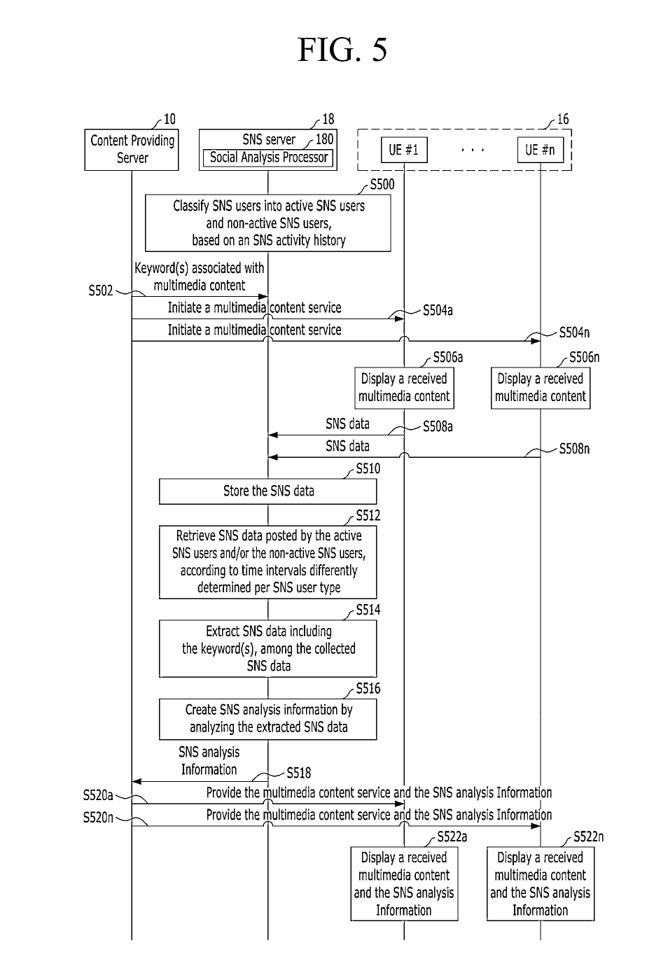

Meanwhile, as shown in FIG. 1B, a social analysis function of social analysis server 12 may be embodied in SNS server 18. Herein, SNS server 18 may include social analysis processor 180. Accordingly, in this case, SNS server 18 according to at least one embodiment may provide an SNS service and perform the social analysis of SNS data. Unlike embodiments shown in FIG. 1A, content providing sever 10 in FIG. 1B may provide one or more keywords associated with a corresponding multimedia content, to SNS server 18. SNS server 18 may receive the one or more keywords, analyze SNS data based on the one or more keywords, and/or provide an SNS analysis result to content providing server 10 and/or user equipment 16. Particularly, with respect to an SNS analysis procedure, SNS users may be classified into active SNS users and non-active SNS users, based on an SNS activity amount. In this case, SNS data collection/analysis periods may be differently determined between the active SNS users and the non-active SNS users. Such SNS analysis procedure of SNS sever 18 will be described in more detail with reference to FIG. 2, and FIG. 5 to FIG. 8D.

FIG. 2 is a block diagram illustrating a detailed structure of a social analysis system in accordance with at least one embodiment.

Referring to FIG. 2, a social analysis system (e.g., social analysis server 12, or SNS server 18 including social analysis processor 180) in accordance with at least one embodiment may include communication processor 21 and control processor 22. Herein, communication processor 21 and control processor 22 may be communicatively coupled via bus 23. At least one of communication processor 21 and control processor 22 may be configured with at least one hardware processor.

More specifically, communication processor 21 may transmit or receive signals, messages, information, and/or data required for performing the present embodiment, in connection with content providing server 10 and/or one or more user equipment 16. In the case that the social analysis system is social analysis server 12, communication processor 21 may perform transmission and/or reception procedures in connection with one or more SNS servers 14.

Control processor 22 may control operations of social analysis server 12 or social analysis processor 180. In other words, control processor 22 may perform (i) a SNS user classification procedure based on an SNS activity amount, (ii) a SNS data collection procedure, (iii) an analysis procedure of the collected SNS data. More specifically, and/or (iv) an SNS analysis result providing procedure. Control processor 22 may include user management unit 221, SNS data collection unit 222, and SNS data analysis unit 223.

User management unit 221 corresponding to a sub-processor may determine and manage an SNS activity amount per SNS user. Furthermore, user management unit 221 may classify SNS users into “active SNS users” and “non-active SNS users” based on the SNS activity amount per SNS user. Herein, the SNS activity may include a variety of activities of using an SNS such as posting (e.g., tweeting) and/or re-posting (e.g., re-tweeting) of SNS data. Accordingly, the SNS activity amount may include the number of times that an SNS is used by a corresponding SNS user. Particularly, the SNS activity amount may be determined as an average value (e.g., a weekly average, a monthly average, etc.). In other embodiments, user management unit 221 may classify in more detail the active SNS users and/or non-active SNS users, according to SNS activity levels (or an SNS activity frequency).

SNS data collection unit 222 corresponding to a sub-processor may collect SNS data posted by the active SNS users and/or the non-active SNS users, according to time intervals differently determined per SNS user type (e.g., active SNS users and non-active SNS users). In this case, the SNS data collection may be periodically performed for a preset analysis time range. Herein, the preset analysis time range may be a time range for collecting and analyzing SNS data. The preset analysis time range may be differently determined per multimedia content. For example, in case of a live broadcast, the preset analysis time range may be determined as a time range from a broadcast start time to a broadcast end time. Furthermore, in the case that a multimedia content includes a plurality of themes (e.g., “North Korea's nuclear test,” and “school without violence”), the preset analysis time range may be separately determined per theme. For example, each broadcast time for each theme may correspond to a corresponding analysis time range.

More specifically, SNS data collection unit 222 may collect SNS data created by the active SNS user, at a first time interval (e.g., in a unit of 5 minutes) in a preset analysis time range (e.g., in case of a live broadcast, from a broadcast start time to a broadcast end time). SNS data collection unit 222 may collect SNS data created by the non-active SNS, at a second time interval (e.g., in a unit of 3 hours) in a preset analysis time range (e.g., from a broadcast start time to a broadcast end time). Herein, the first time interval (e.g., a unit of minutes) may be shorter than the second time interval (e.g., a unit of hours or days). In other embodiment, SNS data collection unit 222 may periodically collect SNS data created by only the active SNS users. In the case that the active SNS users and/or non-active SNS users are classified in more detail according to SNS activity levels (or an SNS activity frequency), an SNS data collection time interval may be differently determined according to SNS activity levels.

SNS data analysis unit 223 corresponding to a sub-processor may create SNS analysis information associated with a specific multimedia content, by analyzing the collected SNS data. More specifically, SNS data analysis unit 223 may extract SNS data (e.g., SNS messages) including one or more keywords associated with a corresponding multimedia content, among the collected SNS data. Herein, the one or more keywords may be received from content providing sever 10. Thereafter, SNS data analysis unit 223 may create SNS analysis information by analyzing data attributes of the extracted SNS data. For example, SNS data analysis unit 223 may perform at least one of (i) an SNS data amount (i.e., buzz amount) analysis, (ii) a post/re-post proportion analysis, (iii) a positive/negative response analysis, and (iv) a related keyword analysis. Furthermore, the SNS analysis information may be expressed using a visual expression means (e.g., graphs, or charts). The SNS analysis information may include (i) a first layout which provides basic analysis information (e.g., statistical graphs and texts associated with SNS data analysis results) and icons (e.g., 710a to 710d) therefor, and (ii) a second layout which provides detailed analysis information and/or corresponding SNS data. In some embodiments, SNS analysis information may include control function data associated with a display (or exposure) of the SNS analysis information. Alternatively, the control function data may be separately provided from a corresponding server (e.g., content providing sever 10, social analysis sever 12, or SNS server 18) to one or more user equipment 16. In the case that user equipment receives the display control function data, a user may selectively display only specific analysis information on a screen of user equipment, by using a display control function. For example, in the case that user equipment receives the display control function data, the user equipment may provide a user interface (e.g., a user interface where a user can select “items to be displayed” and/or “items not to be displayed”) associated with the display control function. In this case, if a user selects only the item “social briefing” as items to be displayed, only SNS analysis information corresponding to the social briefing may be displayed.

When SNS analysis information is created by control processor 22 (more specifically, SNS data analysis unit 223), communication processor 21 may transmit the created SNS analysis information to at least one of content providing server 10 (see FIG. 4 and FIG. 5) and one or more user equipment 16 (see FIG. 6A and FIG. 6B). For example, in the case that a social analysis system (e.g., social analysis server 12 or SNS server 18) directly transmits a first layout (including basic analysis information) to corresponding user equipment, communication processor 21 of the social analysis system may receive a request for a second layout (including detailed analysis information) from user equipment. In this case, communication processor 21 may transmit the detailed analysis information in response to the request, to the corresponding user equipment.

An SNS user classification, an SNS data collection, and/or an SNS data analysis performed by control processor 22 will be described in more detail with reference to FIG. 4 through FIG. 8D.

FIG. 3 is a block diagram illustrating a detailed structure of user equipment in accordance with at least one embodiment.

Referring to FIG. 3, user equipment (e.g., user equipment 16) in accordance with at least one embodiment may include communication processor 31, input/output (I/O) device 32, and control processor 32. Herein, communication processor 31, I/O device 32, and control processor 33 may be communicatively coupled via bus 34.

Communication processor 21 may transmit or receive signals, messages, information, and/or data required for performing the present embodiment, in connection with content providing server 10, social analysis server 12, and/or SNS server 14 or 18. Communication processor 21 may send SNS data (e.g., SNS messages) created by a corresponding user to SNS sever 14 or 18. Communication processor 21 may receive a multimedia content and/or SNS analysis information (i.e., an SNS analysis result) from content providing server 10, as shown in FIG. 4 and FIG. 5. Alternatively, as shown in FIG. 6A and FIG. 6B, communication processor 21 may receive SNS analysis information directly from social analysis server 12 or SNS server 18, without via content providing server 10.

Input/output (I/O) device 32 may include an input device, an output device and/or a combined input/output device for enabling user interaction with the user equipment 16. An input device may include, for example, a keyboard, keypad, mouse, a touch pad, a touch screen, and/or cursor direction keys for communicating information and commands to control processor 33 and/or communication processor 31. An output device may include, for example, a display, a voice synthesizer, etc. for communicating information to a user.

Control processor 33 may control operations of user equipment 16. More specifically, control processor 33 may include content playing unit 331 and SNS analysis information display control unit 332.

Content playing unit 331 corresponding to a sub-processor may play the received multimedia content, through the output device of I/O device 32. Herein, the received multimedia content may be a variety of multimedia content such as a live broadcast content or a non-live broadcast content.

SNS analysis information display control unit 332 corresponding to a sub-processor may display the received SNS analysis information, through the output device of I/O device 32. Furthermore, SNS analysis information display control unit 332 may display detailed analysis information and/or corresponding SNS data (e.g., corresponding SNS messages). In this case, SNS analysis information display control unit 332 may provide a user interface function for a request or selection of users. Herein, user's request or selection may be performed by a variety of user inputs (e.g., a button input, a touch input, etc.) through I/O device 32 (e.g., a mouse device, a touch screen, etc.).

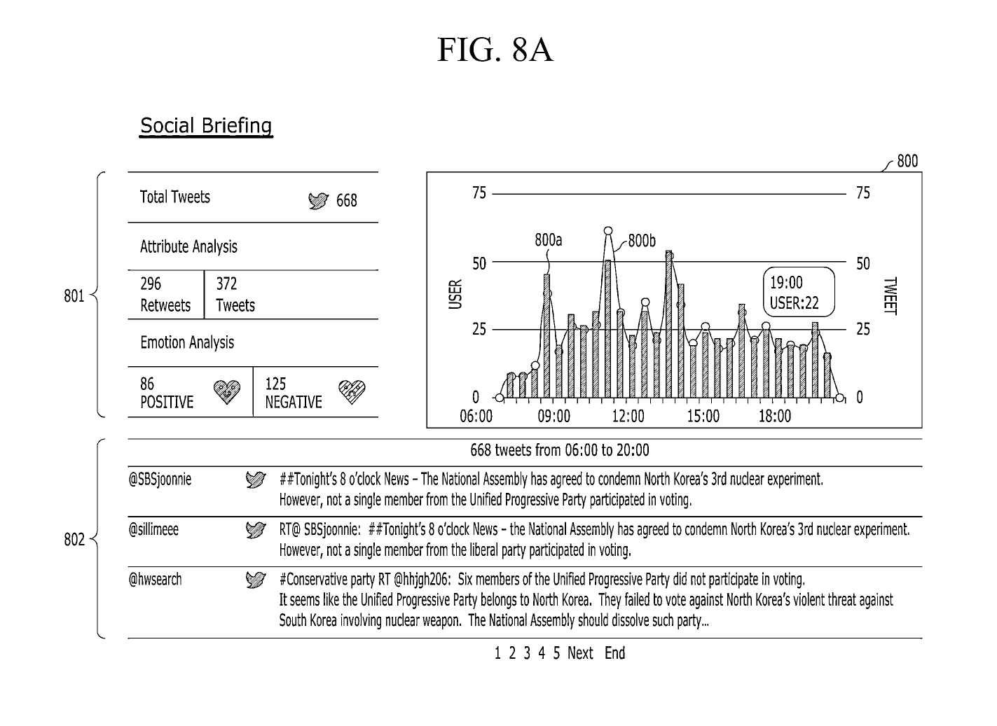

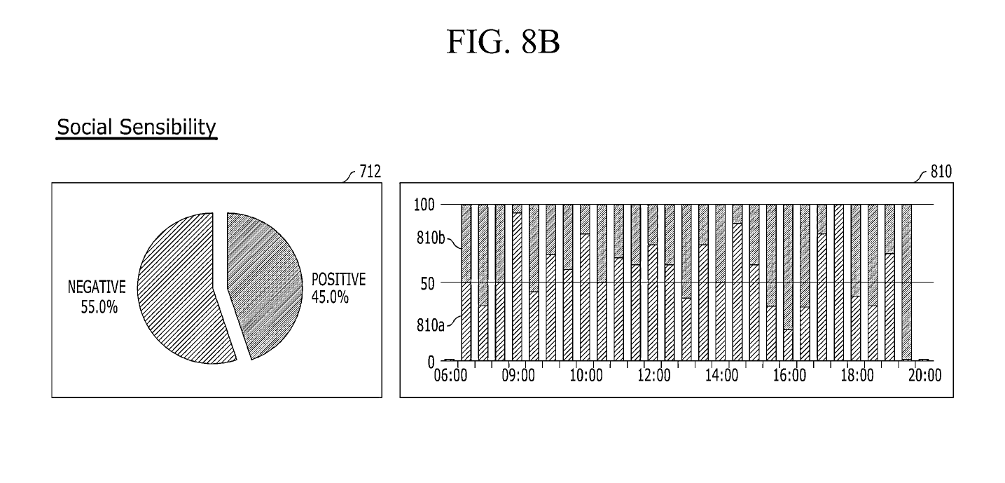

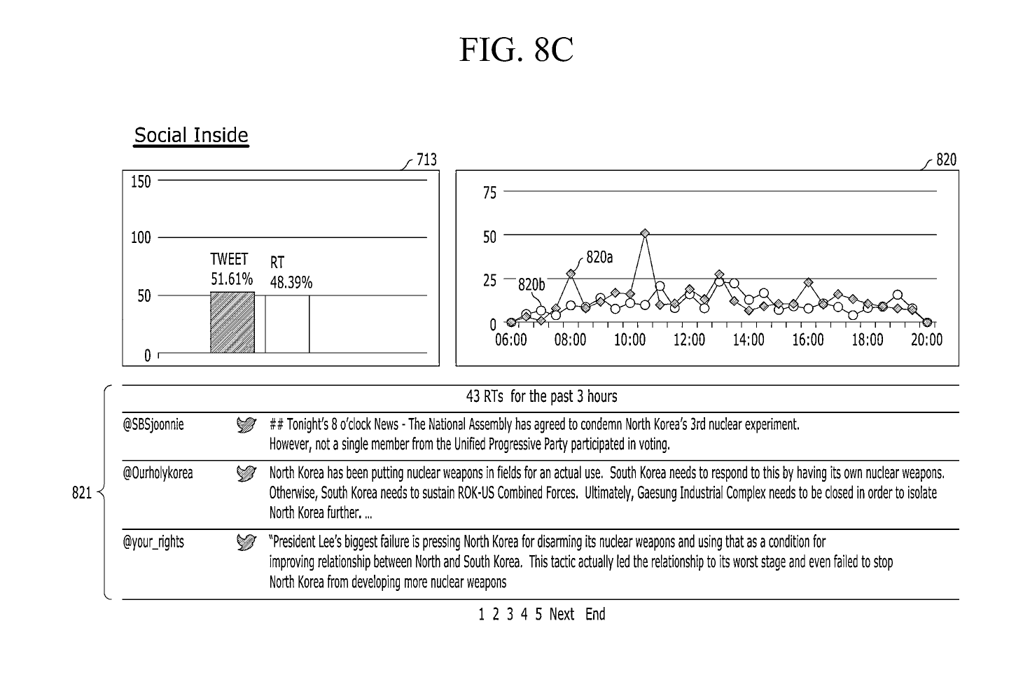

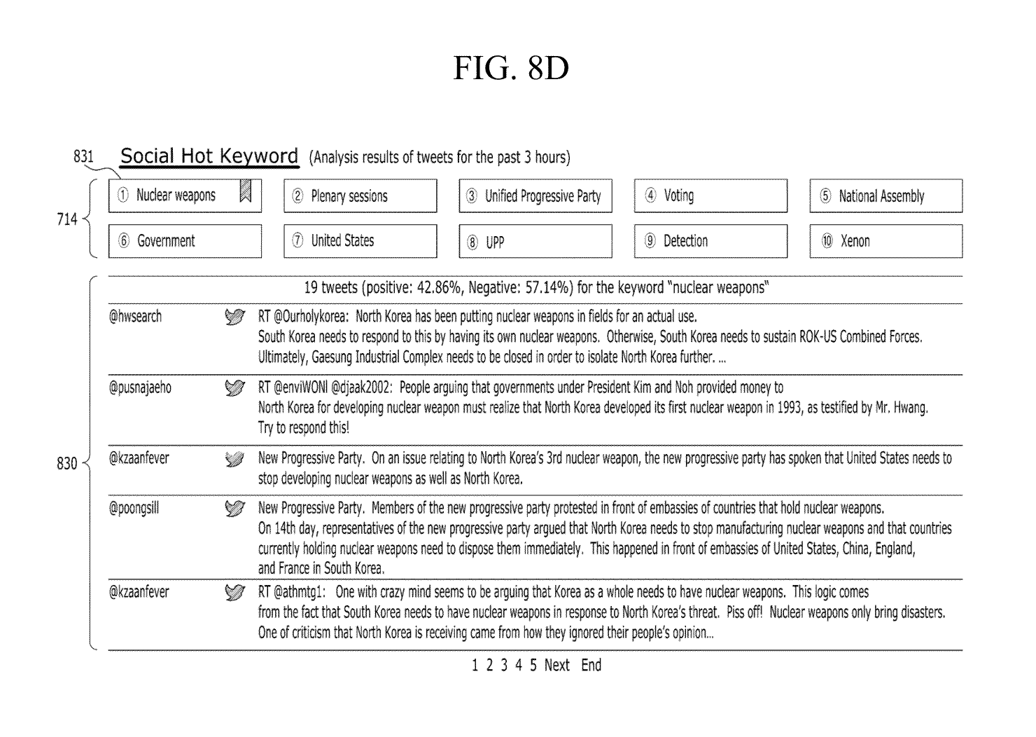

For example, in case of a live broadcast, SNS analysis information display control unit 332 may display the SNS analysis information on screen, while playing the live broadcast. In the case that the SNS analysis information includes basic analysis information (e.g., 710 to 714), when a user selects a certain icon (e.g., 710a) of the basic analysis information, user equipment may transmit a request for a corresponding detailed analysis information (e.g., FIG. 8A) to a corresponding server (e.g., content providing server 10 of FIGS. 4 and 5, social analysis server 12 of FIG. 6A, or SNS server 18 of FIG. 6B), through communication processor 31. In this case, the corresponding server may transmit the corresponding detailed analysis information (e.g., FIG. 8A) to the user equipment in response to the request. When receiving the corresponding detailed analysis information (e.g., FIG. 8A) from the corresponding server, SNS analysis information display control unit 332 of the user equipment may display the received detailed analysis information (e.g., FIG. 8A).

In other embodiments, SNS analysis information received from a corresponding server (e.g., content providing server 10 of FIGS. 4 and 5, social analysis server 12 of FIG. 6A, or SNS server 18 of FIG. 6B) may include (i) a first layout configured to provide basic analysis information and (ii) a second layout configured to provide detailed analysis information. In this case, SNS analysis information display control unit 332 may display the basic analysis information or the detailed analysis information according to a user selection, without transmitting a request to the corresponding server.

A procedure of providing (or displaying) the SNS analysis information in the user equipment (e.g., 16) will be described in more detail with reference to FIG. 4 through FIG. 8D.

In some embodiments, SNS analysis information display control unit 332 may provide a control function (i.e., display control function) associated with a display of SNS analysis information. Accordingly, a user may selectively display only specific analysis information on a screen of user equipment, by using the display control function. For example, SNS analysis information display control unit 332 may provide a user interface (e.g., a user interface where a user can select “items to be displayed” and/or “items not to be displayed”) associated with the display control function. In this case, if a user selects only the item “social briefing” as items to be displayed, only SNS analysis information corresponding to the social briefing may be displayed. In other embodiments, display control function data may be included in SNS analysis information. That is, a corresponding server (e.g., content providing sever 10, social analysis sever 12, or SNS server 18) may provide the SNS analysis information including the display control function data, to one or more user equipment 16. Alternatively, the display control function data may be separately provided from a corresponding server (e.g., content providing sever 10, social analysis sever 12, or SNS server 18) to one or more user equipment 16.

FIG. 4 illustrates a method of performing a real-time social analysis (i.e., a real-time analysis of SNS data) for a multimedia content service in an SNS analysis server (e.g., 12) in accordance with at least one embodiment. Particularly, as shown in FIG. 1A, social analysis server 12 configured separately from one or more SNS server 14 may perform a real-time analysis of SNS data.

Referring to FIG. 4, at step S400, social analysis server 12 may classify SNS users based on an SNS activity amount. More specifically, social analysis server 12 may periodically collect a variety of SNS data from one or more SNS servers 14, and accumulatively store/manage the collected SNS data. In this case, social analysis server 12 may analyze an SNS activity amount per SNS user, based on the stored SNS data. Herein, the SNS activity may include a variety of activities of using an SNS such as posting (e.g., tweeting) or re-posting (e.g., re-tweeting) of SNS data. Accordingly, the SNS activity amount may include the number of times that an SNS is used by a corresponding SNS user. Furthermore, the SNS activity amount may be determined as an average value (e.g., a weekly average, a monthly average, etc.). In some embodiments, social analysis server 12 may periodically re-determine an SNS activity amount per SNS user.

Referring back to step S400, social analysis server 12 may classify SNS users into active SNS users and non-active SNS users, based on an SNS activity amount per SNS user. Herein, the SNS users may indicate users having SNS accounts. For example, in the case that a certain SNS user uses an SNS at least once a week on average, the SNS user may be classified as an active SNS user. Meanwhile, in the case that a certain SNS user uses under once a week on average, the SNS user may be classified as a non-active SNS user. In other embodiments, the active SNS users and/or the non-active SNS servers may be classified in more detail according to SNS activity levels (or an SNS activity frequency). For example, in the case that user ‘A’ posts ten SNS messages on average per week, and user ‘B posts five SNS messages on average per week, an SNS activity level of user ‘A’ is higher than that of user ‘B’.

At step S402, content providing server 10 may transmit at least one keyword associated with a multimedia content to be provided to one or more user equipment 16, to social analysis server 12. More specifically, in at least one embodiment, content providing server 10 may transmit at least one keyword associated with a multimedia content to social analysis server 12, before initiating a multimedia content service (e.g., a live broadcast), for a real-time analysis of SNS data. For example, in the case that the multimedia content relates to a debate program, and a theme of the multimedia content is “North Korea's nuclear test,” content providing server 10 may transmit the words “North Korea” and “UN” as keywords associated with the multimedia. In other embodiments, in the case that one content providing service (e.g., a debate broadcast program) includes a plurality of broadcast themes (e.g., “North Korea's nuclear test,” and “school without violence”), keywords may be determined and transmitted per broadcast theme. Herein, the keyword associated with the multimedia content may be determined by a content provider or a server operator. In other embodiments, an operator of social analysis sever 12 may input one or more keywords associated with a multimedia content, to social analysis server 12.

Meanwhile, when receiving at least one keyword associated with a multimedia content from content providing server 10, social analysis server 12 may store and manage the received keyword(s). For example, social analysis server 12 may manage corresponding keywords per multimedia content.

At steps S404a through S404n, content providing server 10 may initiate a multimedia content service (e.g., a live broadcast) to one or more user equipment 16 (e.g., UE #1, . . . , UE #n). In some embodiments, when receiving a request for a specific content from one or more user equipment 16, content providing server 10 may transmit the specific content to the one or more user equipment 16. In this case, content providing server 10 may transmit a multimedia content, using a variety of transmission schemes such as a streaming transmission scheme, a broadcast transmission scheme, a multicast transmission scheme, and so forth.

At steps S406a through S406n, when receiving a multimedia content from content providing server 10, each user equipment 14 may display the received multimedia content. Accordingly, in case of a live broadcast, users may watch the live broadcast through their user equipment.

At steps S408a through S408n, when users (e.g., SNS users) create SNS data (e.g., SNS messages), user equipment 16 may transmit the created SNS data to SNS server 14. In case of a live broadcast, while watching the live broadcast, users may post or re-post SNS messages to SNS server 14. Although not shown in FIG. 4, third users not watching the live broadcast may send (e.g., repost or retweet) SNS messages associated with the live broadcast. For example, in the case that a user ‘A’ receives a live broadcast service, the user ‘A’ may post (or tweet) an SNS message associated with a theme of the live broadcast. In this case, the posted SNS message of the user ‘A’ may be shared with other users (e.g., user ‘B’) who are not watching the live broadcast. One or more other users (e.g., user ‘B’) other than user ‘A’ may post or re-post a variety of SNS messages associated with the theme of the live broadcast. Accordingly, SNS server 14 may receive and store a variety of SNS messages from SNS users (e.g., users ‘A’ and ‘B’).

Meanwhile, at step S410, in order to perform a social analysis associated with a corresponding multimedia content service, social analysis server 12 may collect SNS data created (e.g., posted or re-posted) by the active SNS users and/or the non-active SNS users, according to time intervals differently determined per SNS user type. In this case, social analysis server 12 may collect SNS data of SNS users corresponding to active/non-active SNS users classified at step S400. Social analysis server 12 may collect SNS data from one or more corresponding SNS sites (i.e., SNS servers, for example, Twitter, Facebook, etc.), using a crawler function. Herein, the crawler function may be performed based on user ID.

More specifically, social analysis server 12 may collect SNS data created by the active SNS user, at a first time interval (e.g., in a unit of 5 minutes) in a preset analysis time range. Herein, the preset analysis time range may be a time range for collecting and analyzing SNS data. The preset analysis time range may be differently determined per multimedia content. For example, in case of a live broadcast, the preset analysis time range may be determined as a time range from a broadcast start time to a broadcast end time. Furthermore, in the case that a multimedia content includes a plurality of themes (e.g., “North Korea's nuclear test,” and “school without violence”), the preset analysis time range may be separately determined per theme. For example, each broadcast time for each theme may correspond to a corresponding analysis time range.

In other embodiments, as described above, the active SNS users may be classified in more detail according to SNS activity levels (or an SNS activity frequency). In this case, a collection time interval may be differently determined according to SNS activity levels. For example, in the case that active user ‘A’ posts ten SNS messages on average per week, and active user ‘B’ posts five SNS messages on average per week, an SNS activity level of active user ‘A’ is higher than that of active user ‘B’. Accordingly, in this case, collection time intervals for active users having a higher SNS activity level may be shorter than active users having a lower SNS activity level.

Social analysis server 12 may collect SNS data created by the non-active SNS, at a second time interval (e.g., in a unit of 3 hours) in a preset analysis time range (e.g., from a broadcast start time to a broadcast end time). Herein, the first time interval (e.g., a unit of minutes) may be shorter than the second time interval (e.g., a unit of hours or days). In other embodiments, as described above, the non-active SNS users may be classified in more detail according to SNS activity levels (or an SNS activity frequency). In this case, a collection time interval may be differently determined according to SNS activity levels. Meanwhile, in other embodiments, social analysis server 12 may periodically collect SNS data created by only the active SNS users.

At step S412, social analysis server 12 may extract SNS data associated with the at least one keyword received from content providing server 10, from the collected SNS data (i.e., SNS data collected at step S410). More specifically, social analysis server 12 may extract only SNS data including the at least one keyword, among the collected SNS data. For example, in the case that the at least one keyword received from content providing server 10 is “North Korea,” social analysis server 12 may extract messages including the word “North Korea” from the SNS data collected at step S410.

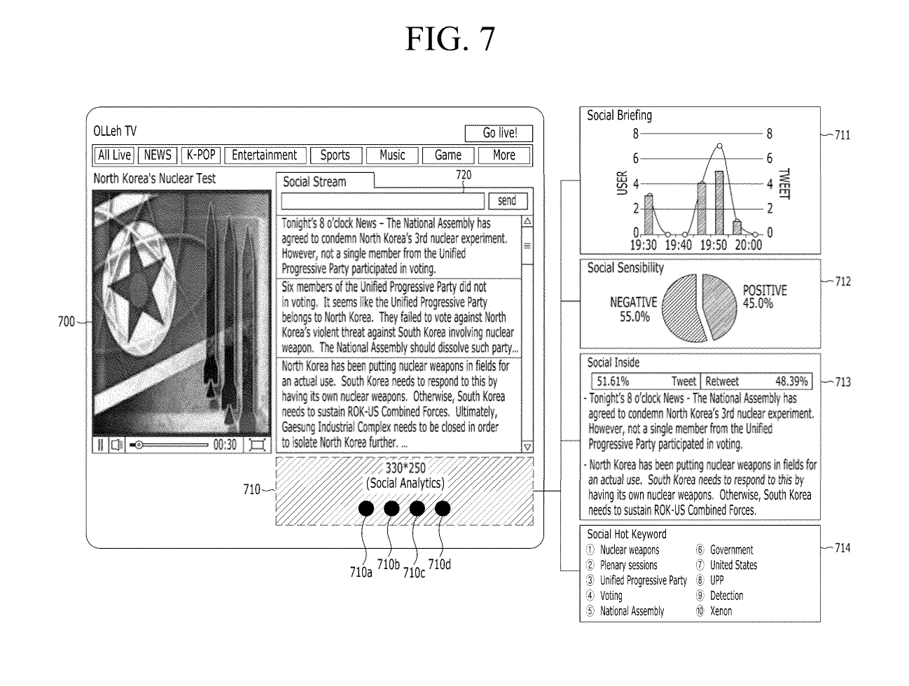

At step S414, social analysis server 12 may create SNS analysis information by analyzing data attributes of the extracted SNS data. More specifically, social analysis server 12 may perform at least one of (i) an SNS data amount (i.e., buzz amount) analysis, (ii) a post/re-post proportion analysis, (iii) a positive/negative response analysis, and (iv) a related keyword analysis. Accordingly, social analysis server 12 may obtain an SNS analysis result (i.e., SNS analysis information) including at least one of (i) an SNS data amount per time slot, (ii) proportion of original posted data (e.g., the number of tweets in the SNS Twitter) and re-posted data (e.g., the number of retweets), (iii) proportion of positive/negative responses, (iv) social hot keywords (i.e., related keywords), and (v) the number of citations of each SNS data (e.g., an SNS message). Particularly, the SNS analysis result (i.e., SNS analysis information) may be created in the form of statistical data. In some embodiments, the SNS analysis result may be expressed in a form of graphs. Herein, the graphs may include bar graphs, line graphs, area graphs, scatter graphs, pie graphs, 3D graphs, and stock graphs, but are not limited thereto. Furthermore, the SNS analysis result may be mapped to corresponding SNS data (e.g., corresponding SNS messages) which were analyzed. Such created SNS analysis information will be described in more detail with reference to FIG. 7 through FIG. 8D.

With respect to the positive/negative response analysis, social analysis server 12 may extract SNS data including one or more emotion words (e.g., one or more words expressing a positive or negative emotion), from SNS data extracted at step S414, and calculate proportions of positive/negative responses of the SNS data including the one or more emotion words. For example, SNS messages including the words “bad,” or “disagree” may be classified as “negative responses.” SNS messages including the words “good” or “agree” may be classified as “positive responses.”

With respect to the social hot keywords, social analysis server 12 may obtain one or more related keywords (e.g., nuclear weapons, UN, etc.) with the at least one keyword (or may be referred to as “original keywords,” for example, North Korea) received from content providing server 10. Herein, the related keywords may be words which are frequently used along with the original keywords. In this case, social analysis server 12 may extract SNS data including the related keywords, from the collected SNS data (i.e., SNS data collected at step S410). Alternatively, social analysis server 12 may extract SNS data including the related keywords, from the extracted SNS data including the original keyword(s). As shown in the following FIG. 8D, social analysis server 12 may classify and analyze the extracted SNS data including the related keyword(s), per related keyword.

At step S416, social analysis server 12 may transmit SNS analysis information to content providing server 10. Herein, the SNS analysis information may include all or a portion of the extracted SNS data (i.e., the extracted SNS messages). In this case, user equipment 16 may display the received SNS analysis information along with a received multimedia content. Accordingly, users may see the SNS analysis information while watching a corresponding multimedia content (e.g., a live broadcast). In another embodiment, social analysis server 12 may transmit the SNS analysis information directly to corresponding user equipment 16. The other embodiments will be described with reference to FIG. 6A.

At steps S418a through S418n, when receiving the SNS analysis information from social analysis server 12, content providing server 10 may provide the received SNS analysis information to the one or more user equipment 16, while providing the multimedia content service (e.g., corresponding content data of a live broadcast) to the one or more user equipment 16. Herein, the SNS analysis information may include (i) a first layout which provides basic analysis information (e.g., statistical graphs and texts associated with SNS data analysis results) and icons therefor, and (ii) a second layout which provides detailed analysis information and/or corresponding SNS data. More specifically, the basic analysis information (e.g., 710) may include (a) a plurality of icons (e.g., 710a, 710b, 710c, 710d) for presenting basic analysis information (e.g., 711, 712, 713, 714), and (b) a variety of basic analysis information (e.g., 711, 712, 713, 714) per analysis type. The detailed analysis information (e.g., FIG. 8A through FIG. 8D) per analysis type may include (a) detailed analysis information expressed in a form of graph or text, and (b) corresponding SNS data (e.g., SNS messages such as “802,” “821,” or “830”). In at least one embodiment, content providing server 10 may provide the basic analysis information and the detailed analysis information together to one or more user equipment 16. In other embodiments, content providing server 10 may first provide the basic analysis information, and provide the detailed analysis information in response to a user selection through the basic analysis information. Such SNS analysis information will be described in more detail with reference to FIG. 7 through FIG. 8D.

At steps S420a through S420n, when receiving the SNS analysis information and the multimedia content providing service from content providing server 10, one or more user equipment 16 may display a received multimedia content and the SNS analysis information. For example, in case of a live broadcast, one or more user equipment 16 may display the SNS analysis information on screen, while playing the live broadcast. In the case that the SNS analysis information includes the basic analysis information (e.g., 710), when a user selects a certain icon (e.g., 710a) of the basic analysis information, a corresponding user equipment may transmit a request for a corresponding detailed analysis information (e.g., FIG. 8A). In this case, content providing server 10 may transmit the corresponding detailed analysis information (e.g., FIG. 8A) to the corresponding user equipment in response to the request. When receiving the corresponding detailed analysis information (e.g., FIG. 8A) from content providing server 10, the corresponding user equipment may display the received detailed analysis information (e.g., FIG. 8A).

Although not shown in FIG. 4, during the live broadcast, an SNS data collection (410), an SNS data extraction (S412), an SNS analysis (S414), and an SNS analysis information providing process (S418a through S418n) may be periodically performed. Furthermore, in the case that one multimedia content (e.g., a debate broadcast program) includes a plurality of broadcast themes (e.g., “North Korea's nuclear test,” and “school without violence”), an SNS data collection (S410), an SNS data extraction (S412), an SNS analysis (S414), and an SNS analysis information providing process (S418a through S418n) may be performed for each broadcast theme. In other words, an SNS analysis result may be separately obtained based on one or more keywords independently determined per theme. For example, during a first broadcast theme (e.g., North Korea's nuclear test) is broadcasted, an SNS data collection (S410), an SNS data extraction (S412), an SNS analysis (S414), and an SNS analysis information providing process (S418a through S418n) be performed based on one or more first keywords and related keywords thereof. In the case that the first broadcast theme during a first broadcast theme (e.g., North Korea's nuclear test) is changed into a second broadcast theme (e.g., school without violence), an SNS data collection (S410), an SNS data extraction (S412), an SNS analysis (S414), and an SNS analysis information providing process (S418a through S418n) may be separately performed based on one or more second keywords (e.g., “violence”) and related keywords thereof (e.g., “youth,” “school,” “club”). In the case that an SNS data collection is newly performed according to the second broadcast theme, the previous keywords and SNS data collected and analyzed in connection with the first broadcast theme may be deleted.

FIG. 5 illustrates another method of performing a real-time social analysis (i.e., a real-time analysis of SNS data) for a multimedia content service in an SNS server (e.g., 18) in accordance with other embodiments. Particularly, as shown in FIG. 1B, SNS server 18 including social analysis processor 180 may perform a real-time analysis of SNS data.

Referring to FIG. 5, at step S500, SNS server 18 may classify SNS users based on an SNS activity amount. More specifically, SNS server 18 may accumulatively store/manage SNS data. In this case, SNS server 18 may analyze an SNS activity amount per SNS user, based on the stored SNS data. Herein, the SNS activity may include a variety of activities of using an SNS such as posting (e.g., tweeting) or re-posting (e.g., re-tweeting) of SNS data. Accordingly, the SNS activity amount may include the number of times that an SNS is used by a corresponding SNS user. Furthermore, the SNS activity amount may be determined as an average value (e.g., a weekly average, a monthly average, etc.). In some embodiments, SNS server 18 may periodically re-determine an SNS activity amount per SNS user.

Referring back to step S500, SNS server 18 may classify SNS users into active SNS users and non-active SNS users, based on an SNS activity amount per SNS user. Herein, the SNS users may indicate users having SNS accounts. For example, in the case that a certain SNS user uses an SNS at least once a week on average, the SNS user may be classified as an active SNS user. Meanwhile, in the case that a certain SNS user uses under once a week on average, the SNS user may be classified as a non-active SNS user. In other embodiments, the active SNS users may be classified in more detail according to SNS activity levels (or an SNS activity frequency). In other embodiments, as described at step S400 of FIG. 4, the active SNS users and/or the non-active SNS servers may be classified in more detail according to SNS activity levels (or an SNS activity frequency).

At step S502, content providing server 10 may transmit at least one keyword associated with a multimedia content to be provided to one or more user equipment 16, to SNS server 18. More specifically, in at least one embodiment, content providing server 10 may transmit at least one keyword associated with a multimedia content to SNS server 18, before initiating a multimedia content providing service (e.g., a live broadcast), for a real-time analysis of SNS data. For example, in the case that the multimedia content relates to a debate program, and a theme of the multimedia content is “North Korea's nuclear test,” content providing server 10 may transmit the words “North Korea” and “UN” as keywords associated with the multimedia. In other embodiments, in the case that one content providing service (e.g., a debate broadcast program) includes a plurality of broadcast themes (e.g., “North Korea's nuclear test,” and “school without violence”), keywords may be determined and transmitted per broadcast theme. Herein, the keyword associated with the multimedia content may be determined by a content provider or a server operator. In other embodiments, an operator of SNS Sever 18 may input one or more keywords associated with a multimedia content, to SNS server 18.

Meanwhile, when receiving at least one keyword associated with a multimedia content from content providing server 10, SNS server 18 may store and manage the received keyword(s). For example, SNS server 18 may manage corresponding keywords per multimedia content.

At steps S504a through S504n, content providing server 10 may initiate a multimedia content service (e.g., a live broadcast) to one or more user equipment 16 (e.g., UE #1, . . . , UE #n). In some embodiments, when receiving a request for a specific content from one or more user equipment 16, content providing server 10 may transmit the specific content to the one or more user equipment 16. In this case, content providing server 10 may transmit a multimedia content, using a variety of transmission schemes such as a streaming transmission scheme, a broadcast transmission scheme, a multicast transmission scheme, a unicast transmission, and so forth.

At steps S506a through S506n, when receiving a multimedia content from content providing server 10, each user equipment 14 may display the received multimedia content. Accordingly, in case of a live broadcast, users may watch the live broadcast through their user equipment.

At steps S508a through S508n, when users (e.g., SNS users) create SNS data (e.g., SNS messages), one or more user equipment 16 may transmit the created SNS data to SNS server 18. In case of a live broadcast, while watching the live broadcast, users may post or re-post SNS messages to SNS server 18. Although not shown in FIG. 5, third users not watching the live broadcast may send (or re-post) SNS messages associated with the live broadcast. For example, in the case that a user ‘A’ receives a live broadcast service, the user ‘A’ may post (or tweet) an SNS message associated with a theme of the live broadcast. In this case, the posted SNS message of the user ‘A’ may be shared with other users (e.g., user ‘B’) who are not watching the live broadcast. One or more other users (e.g., user ‘B’) other than user ‘A’ may post or re-post a variety of SNS messages associated with the theme of the live broadcast. Accordingly, SNS server 18 may receive and store a variety of SNS messages from SNS users (e.g., users ‘A’ and ‘B’).

At step S510, when receiving SNS data, SNS server 18 may store the received SNS data. More specifically, SNS server 18 may store and manage the received SNS data, using one or more databases.

At step S512, in order to perform a social analysis associated with a corresponding multimedia content service, SNS server 18 may retrieve (or collect) SNS data created (e.g., posted or re-posted) by the active SNS users and/or the non-active SNS users, according to time intervals differently determined per SNS user type. In this case, SNS server 18 may retrieve SNS data of SNS users corresponding to active/non-active SNS users classified at step S500. SNS server 18 may retrieve (or collect) corresponding SNS data from the stored SNS data, based on user IDs.

More specifically, SNS server 18 may retrieve (or collect) SNS data created by the active SNS user, at a first time interval (e.g., in a unit of 5 minutes) in a preset analysis time range (e.g., in case of a live broadcast, from a broadcast start time to a broadcast end time). SNS server 18 may retrieve (or collect) SNS data created by the non-active SNS, at a second time interval (e.g., in a unit of 3 hours) in a preset analysis time range (e.g., from a broadcast start time to a broadcast end time). Herein, the first time interval (e.g., a unit of minutes) may be shorter than the second time interval (e.g., a unit of hours or days). In other embodiment, SNS server 18 may periodically retrieve (or collect) SNS data created by only the active SNS users. Since an SNS data retrieval (or collection) procedure was already described with reference to FIG. 4 (especially, S410), the detailed description thereof is omitted.

At step S514, SNS server 18 may extract SNS data associated with the at least one keyword received from content providing server 10, from the retrieved (or collected) SNS data. More specifically, SNS server 18 may extract only SNS data including the at least one keyword, among the retrieved SNS data.

At step S516, SNS server 18 may create SNS analysis information by analyzing data attributes of the extracted SNS data. More specifically, SNS server 18 may perform at least one of (i) an SNS data amount (i.e., buzz amount) analysis, (ii) a positive/negative response analysis, (iii) an SNS data sharing type analysis (i.e., a post/re-post proportion analysis, and (iv) a related keyword analysis. Accordingly, SNS server 18 may obtain an analysis result (i.e., SNS analysis information) including at least one of (i) an SNS data amount per time slot, (ii) proportion of positive/negative responses, (iii) proportion of original posted data (e.g., the number of tweets in the SNS Twitter) and re-posted data (e.g., the number of retweets), (iv) social hot keywords (i.e., related keywords), and (v) the number of citations of each SNS data. In some embodiments, the SNS analysis result may be expressed in a form of graphic data. Furthermore, the SNS analysis result may be mapped to corresponding SNS data (e.g., corresponding posted SNS messages) which were analyzed. Since a procedure of creating SNS analysis information was already described with reference to FIG. 4 (especially, S414), the detailed description thereof is omitted. Furthermore, such created SNS analysis information will be described in more detail with reference to FIG. 7 through FIG. 8D.

At step S518, SNS server 18 may transmit SNS analysis information to content providing server 10. In other embodiment, SNS server 18 may transmit the SNS analysis information to corresponding user equipment 16. Herein, the SNS analysis information may include all or a portion of the extracted SNS data. In this case, the corresponding user equipment 16 may display the received SNS analysis information along with a received multimedia content. Accordingly, users may see the SNS analysis information while watching a corresponding multimedia content (e.g., a live broadcast). In another embodiment, SNS server 18 may transmit the SNS analysis information directly to corresponding user equipment 16. The another embodiments will be described with reference to FIG. 6B.

At steps S520a through S520n, when receiving the SNS analysis information from SNS server 18, content providing server 10 may provide the received SNS analysis information to the one or more user equipment 16, while transmitting a corresponding multimedia content (e.g., corresponding content data of a live broadcast) to the one or more user equipment 16. Since the SNS analysis information was already described with reference to FIG. 4, the detailed description thereof is omitted. Furthermore, such SNS analysis information will be described in more detail with reference to FIG. 7 through FIG. 8D.

At steps S522a through S522n, when receiving the SNS analysis information and the corresponding multimedia content from content providing server 10, one or more user equipment 16 may display the received multimedia content and the SNS analysis information. For example, in case of a live broadcast, one or more user equipment 16 may display the SNS analysis information on screen, while playing the live broadcast. In the case that the SNS analysis information includes the basic analysis information (e.g., 710), when a user selects a certain icon (e.g., 710a) of the basic analysis information, a corresponding user equipment may transmit a request for a corresponding detailed analysis information (e.g., FIG. 8A). In this case, content providing server 10 may transmit the corresponding detailed analysis information (e.g., FIG. 8A) to the corresponding user equipment in response to the request. When receiving the corresponding detailed analysis information (e.g., FIG. 8A) from content providing server 10, the corresponding user equipment may display the received detailed analysis information (e.g., FIG. 8A).

Although not shown in FIG. 5, during the live broadcast, an SNS data reception/storage (S508, S510), an SNS data retrieval (or collection) (S512), an SNS data extraction (S514), an SNS analysis (S516), and an SNS analysis information providing process (S520a through S520n) may be periodically performed. Since repetition of the operations was already described with reference to FIG. 4, the detailed description thereof is omitted.

FIG. 6A and FIG. 6B illustrate other methods of performing a real-time social analysis (i.e., a real-time analysis of SNS data) for a multimedia content server in accordance with other embodiments. Particularly, FIG. 6A and FIG. 6B is related to embodiments in which SNS analysis server 12 in FIG. 4 and/or SNS server 18 in FIG. 5 transmit SNS analysis information directly to one or more user equipment 16.

Referring to FIG. 6A, since the procedures of the present embodiment are substantially similar to those of the embodiment described with reference to FIG. 1A and FIG. 4, the following description will focus on differences therebetween for convenience. That is, the operations of steps S600 through S614 are substantially identical or similar to those of steps S400 through S414.

At steps S616a through S616n, social analysis server 12 may transmit SNS analysis information directly to one or more user equipment 16.

At steps S618a through S618n, content providing server 10 may provide the multimedia content service to the one or more user equipment 16. For example, in case of a live broadcast, content providing server 10 may continue to provide the live broadcast to user equipment 16 as long as the live broadcast time does not end.

At steps S620a through S620n, user equipment 16 may display the received SNS analysis information along with a received multimedia content. Accordingly, users may see the SNS analysis information while watching the corresponding multimedia content (e.g., a live broadcast).

Meanwhile, referring to FIG. 6B, since the procedures of the present embodiment are substantially similar to those of the embodiment described with reference to FIG. 1B and FIG. 5, the following description will focus on differences therebetween for convenience. That is, the operations of steps S650 through S666 are substantially identical or similar to those of steps S500 through S516.

At steps S668a through S668n, SNS server 18 including social analysis processor 180 may transmit SNS analysis information directly to one or more user equipment 16.

At steps S620a through S620n, content providing server 10 may provide the multimedia content service to the one or more user equipment 16. For example, in case of a live broadcast, content providing server 10 may continue to provide the live broadcast to user equipment 16 as long as the live broadcast time does not end.

At steps S622a through S622n, the one or more user equipment 16 may display the received SNS analysis information along with a received multimedia content. Accordingly, users may see the SNS analysis information while watching the corresponding multimedia content (e.g., a live broadcast).

FIG. 7 illustrates first layouts associated with basic SNS analysis information in accordance with at least one embodiment.

In at least one embodiment, in the case that a certain multimedia content (e.g., a live broadcast content) is broadcasted, users may create and send SNS data (e.g., an SNS message) using an input window 720 of corresponding user equipment (e.g., personal computers). In other embodiments, while watching the multimedia content using the corresponding user equipment (e.g., personal computers), the users may create and send SNS data using another user equipment (e.g., smart phones). Herein, the SNS data may be transmitted to a corresponding SNS server (e.g., SNS server 14 or SNS server 18). Furthermore, SNS data posted through the input window 720 may be displayed in a pre-defined portions below the input window 720 of the corresponding user equipment.

When receiving SNS data from one or more user equipment, social analysis server 12 or SNS sever 18 may create SNS analysis information by analyzing the received SNS data associated with the multimedia content. As shown in FIG. 4 and FIG. 5, social analysis server 12 or SNS sever 18 (including social analysis processor 180) may provide the SNS analysis information to one or more user equipment, through content providing server 10. That is, social analysis server 12 or SNS sever 18 may provide the SNS analysis information indirectly to the one or more user equipment. Alternatively, as shown in FIG. 6A and FIG. 6B, social analysis server 12 or SNS sever 18 may directly provide the SNS analysis information to one or more user equipment. When receiving the SNS analysis information from one of content providing server 10 (e.g., S418a through S418n of FIG. 4; or S520a through S520n of FIG. 5), social analysis server 12 (e.g., FIG. 6A), and SNS server 18 (FIG. 6B) according to embodiments, one or more user equipment 16 may display the received SNS analysis information (e.g., 710, 711, 712, 713, 714, 800, 801, 802, 810, 820, 821, 830) while displaying multimedia content (e.g., 700). Herein, the SNS analysis information according to the present embodiments may include (i) a first layout”) which provides basic analysis information (e.g., statistical graphs and texts associated with SNS data analysis results) and icons therefor, and (ii) a second layout which provides detailed analysis information and/or corresponding SNS data (e.g., SNS messages). Hereinafter, for convenience of descriptions, each of “710,” “711,” “712,” “713,” and “714” may be referred to “a first layout.” More specifically, the basic analysis information (e.g., 710) may include (a) a plurality of icons (e.g., 710a, 710b, 710c, 710d) for presenting basic analysis information (e.g., 711, 712, 713, 714), and (b) a variety of basic analysis information (e.g., 711, 712, 713, 714) per analysis type. The detailed analysis information (e.g., FIG. 8A through FIG. 8D) per analysis type may include (a) detailed analysis information expressed in a form of graph or text, and (b) corresponding SNS data (e.g., SNS messages such as “802,” “821,” or “830”).

The first layout (e.g., 710) capable of providing the basic analysis information may be displayed in a banner type on screen of user equipment. Herein, the banner type may be one of widely-used forms of displaying certain information at a specific position in a web page. In this case, the banner type may be a two-way banner. As described above, the first layout (e.g., 710) capable of providing the basic analysis information may include a plurality of icons (e.g., 710a, 710b, 710c, 710d). When a certain icon of the plurality of icons (e.g., 710a through 710d) is selected through a user input interface (e.g., a touch input, mouse cursor, a cursor of a remote controller, etc.), corresponding basic analysis information (e.g., 711, 712, 713, or 714) may be displayed on a predetermined screen region. In this case, when a user input interface (e.g., a mouse cursor, a cursor of a remote controller, etc.) is placed on or near a certain icon, a portion or all of the corresponding basic analysis information may be temporarily displayed.

For example, in the case that a user selects the icon “710a” through a touch input, basic analysis information (e.g., 711) associated with “a social briefing” may be displayed on the region “710.” Herein, the social briefing (e.g., 711) may indicate an SNS analysis result associated with an SNS data amount (i.e., a buzz amount) for a predetermined time period (e.g., for the past 3 hours from the present time). Particularly, the social briefing (e.g., 711) may indicate changes in the number of SNS messages (e.g., tweets) and/or the number of SNS users according to a time change. Herein, in “711” of FIG. 7, the bar graph represents a change in the number of SNS users, and a line graph represents a change in the SNS messages (e.g., tweets).

For another example, in the case that a user selects the icon “710b” through a touch input, basic analysis information (e.g., 712) associated with “a social sensibility” may be displayed on the region “710.” Herein, social sensibility (e.g., 712) may indicate an SNS analysis result associated with social positive/negative responses of SNS messages created (e.g., posted or reposted) for a predetermined time period (e.g., for the past 3 hours from the present time). Particularly, the social sensibility (e.g., 712) may indicate the proportion of total positive responses and total negative responses.

For another example, in the case that a user selects the icon “710c” through a touch input, basic analysis information (e.g., 713) associated with “a social inside” may be displayed on the region “710.” Herein, the social inside (e.g., 713) may indicate an SNS analysis result associated with SNS messages created (e.g., posted and/or reposted) for a predetermined time period (e.g., for the past 3 hours from the present time). Particularly, the social inside (e.g., 713) may indicate the proportion of total posted messages (e.g., tweets) and total re-posted messages (e.g., retweets). Furthermore, as shown in “713” of FIG. 7, corresponding SNS data (e.g., SNS messages) may be arranged according to the number of citations of each SNS data (e.g., each SNS message).

For another example, in the case that a user selects the icon “710d” through a touch input, basic analysis information (e.g., 713) associated with “social hot keywords” may be displayed on the region “710.” Herein, the social hot keywords (e.g., 714) may indicate an SNS analysis result associated with keywords (i.e., related keywords) used along with one or more original keywords for a predetermined time period (e.g., for the past 3 hours from the present time).

Meanwhile, in the case that user equipment receives a user selection for detailed analysis information (“a second layout”) associated with each first layout (e.g., 711, 712, 713, or 714), the user equipment may send a request for a corresponding second layout to one of content providing server 10, social analysis server 12, and SNS server 18. One of content providing server 10, social analysis server 12, and SNS server 18 may provide the corresponding second layout in response to the request, to the user equipment. When receiving the second layout, the user equipment may display the received second layout (including detailed analysis information) as shown in FIG. 8A through FIG. 8D later.

FIG. 8A through FIG. 8D illustrate second layouts associated with detailed SNS analysis information in accordance with at least one embodiment.

In at least one embodiment, as shown in FIG. 4 and FIG. 5, content providing server 10 may first provide “first layouts” (including basic analysis information) to user equipment, and provide “second layout” (including detailed analysis information) to the user equipment in response to a user request. In other embodiments, as shown in FIG. 6A and FIG. 6B, social analysis server 12 or SNS server 18 may first provide the basic analysis information to user equipment, and provide the detailed analysis information to the user equipment in response to a user request. In these cases, when receiving the detailed analysis information, user equipment may display the detailed analysis information. Herein, the user equipment may display the detailed analysis information, using a variety of display schemes (e.g., a pop-up type).

More specifically, referring to FIG. 7 and FIG. 8A, when “a social briefing” (e.g., 711) among a plurality of basic analysis information (i.e., a plurality of first layouts) is selected, user equipment may receive corresponding detailed analysis information (i.e., a corresponding second layout) from content providing server 10. In other embodiments, user equipment may receive the corresponding detailed analysis information (i.e., the corresponding second layout) from social analysis server 12 or SNS server 18. Herein, the detailed analysis information (i.e., the second layout) corresponding to the first layout (e.g., “the social briefing”) may include (i) SNS analysis data 800 expressed in a form of graphs, (ii) SNS analysis data 801 expressed in a form of texts, and/or (iii) corresponding SNS messages 802. SNS analysis data 800 of the detailed analysis information may be the same as SNS analysis data included in the first layout 711. Alternatively, the SNS analysis data 800 of the detailed analysis information may include SNS analysis information associated with a more extended time range than ‘SNS analysis data included in the first layout 711.’

As shown in “800” of FIG. 8A, SNS analysis data expressed in a form of graphs may include the number of SNS users (i.e., users who posted SNS messages) and/or the number of SNS messages (e.g., SNS messages such as tweets posted in real-time) associated with a specific multimedia content. Herein, in FIG. 8A, a bar graph 800a represents the number of SNS users, and a line graph 800b represents the number of SNS messages. For example, when a user interface (e.g., a mouse cursor) comes near to a specific time slot, information on a corresponding time and the number of corresponding SNS users (i.e., the number of SNS users who posted SNS messages at the corresponding time) may be displayed.

As shown in “801” of FIG. 8A, SNS analysis data expressed in a form of texts may include the number of total SNS messages (e.g., the number of total tweets), an attribute analysis result (e.g., tweets vs. retweets) of SNS messages, and/or an emotion analysis result (e.g., positive/negative responses) of SNS messages. For example, in the case that a content theme is “North Korea's nuclear test,” the number of SNS messages (e.g., the number of total tweets) may be “668,” proportions of “retweets” and “tweets” may be “296” to “372.” With respect to the emotion analysis, proportions of positive responses (e.g., 86 SNS messages) and negative responses (e.g., 125 SNS messages) may be displayed as shown in “801” of FIG. 8B. Furthermore, a total number of SNS messages (e.g., a total number of tweets) created for a predetermined time period (e.g., from 06:00 to 20:00) may be displayed. In this case, as shown in “802” of FIG. 8A, SNS messages 802 (e.g., 668 tweets) may be arranged in order of latest time.

Meanwhile, referring to FIG. 7 and FIG. 8B, when “a social sensibility” (e.g., 712) among a plurality of basic analysis information (i.e., a plurality of first layouts) is selected, user equipment may receive corresponding detailed analysis information (i.e., a corresponding second layout) from content providing server 10. In other embodiments, user equipment may receive the corresponding detailed analysis information (i.e., the corresponding second layout) directly from social analysis server 12 or SNS server 18. Herein, the social sensibility may be related to a positive/negative response analysis of SNS data (e.g., SNS messages). Accordingly, the detailed analysis information (i.e., the second layout) corresponding to the first layout (“the social sensibility”) may include (i) positive/negative analysis data 712 expressed in a form of graphs, and (ii) a change (e.g., 810) in positive/negative responses according to elapsing time. More specifically, positive/negative analysis data 712 of pie graph type may represent positive/negative responses of SNS messages posted or reposted for a predetermined time period (e.g., for the past 3 hours from the present time). Particularly, “712” may indicate the proportion of total negative responses (e.g., 55.0%) and total positive responses (e.g., 45.0%). In FIG. 8B, “810a” represents negative responses per time slot, and “810b” represents positive responses per time slot. SNS analysis data 810 (e.g., positive/negative response changes per time slot) of the detailed analysis information may include a more extended time range than SNS analysis data 712.

Referring to FIG. 7 and FIG. 8C, when “a social inside” (e.g., 713) among a plurality of basic analysis information (i.e., a plurality of first layouts) is selected, user equipment may receive corresponding detailed analysis information (i.e., a corresponding second layout) from content providing server 10. In other embodiments, user equipment may receive the corresponding detailed analysis information (i.e., the corresponding second layout) directly from social analysis server 12 or SNS server 18. Herein, the social inside may be related to an SNS data sharing type analysis (i.e., a post/re-post proportion analysis). Accordingly, the detailed analysis information (“second layout”) corresponding to the first layout (“social inside”) may include (i) SNS data sharing type analysis data 713 (e.g., a proportion of original tweet messages and retweet messages) expressed in a form of graphs (e.g., bar graphs), (ii) an SNS sharing type change per time slot 820 (i.e., a change in an SNS data sharing type proportion according to elapsing time), and (iii) corresponding SNS data (e.g., retweeted SNS messages). SNS data sharing type analysis data 713 of a bar graph type may indicate an SNS analysis result associated with total SNS messages posted (e.g., tweeted) and/or reposted (e.g., retweeted) for a predetermined time period (e.g., for the past 3 hours from the present time). Herein, the SNS messages may be messages (e.g., tweet messages and retweet messages) including specific keywords, as described at steps S412 and S514. Particularly, the social inside (e.g., 713) may indicate a bar graph representing the proportion of total posted messages (e.g., tweets) and total re-posted messages (e.g., retweets) for the predetermined time period. SNS analysis data 820 of the detailed analysis information may include a more extended time range than SNS analysis data 713. Herein, “820a” represents posted messages (e.g., tweets) per time slot, and “810b” represents re-posted messages (e.g., retweets) per time slot. Furthermore, as shown in “821” of FIG. 8C, corresponding SNS data (e.g., retweeted SNS messages) may be arranged according to the number of citations of each SNS messages. Alternatively, corresponding SNS data (e.g., retweeted SNS messages) may be arranged in order of the latest time.

Referring to FIG. 7 and FIG. 8D, when “a social hot keyword” (e.g., 714) among a plurality of basic analysis information (i.e., a plurality of first layouts) is selected, user equipment may receive corresponding detailed analysis information (i.e., a corresponding second layout) from content providing server 10. In other embodiments, user equipment may receive the corresponding detailed analysis information (i.e., the corresponding second layout) directly from social analysis server 12 or SNS server 18. Herein, the social hot keyword may be related to an SNS analysis result associated with other keywords (i.e., related keywords) used along with one or more original keywords (e.g., North Korea) for a predetermined time period (e.g., for the past 3 hours from the present time). The detailed analysis information (“second layout”) corresponding to the first layout (“the social hot keyword”) may include (i) the related keywords 714 used along with one or more original keywords, and/or (ii) corresponding SNS messages 830 including the related keywords.

Furthermore, related keywords and corresponding SNS messages may be selectively displayed in one or more user equipment 16 by being controlled by a server (e.g., content providing server 10, social analysis server 12, or SNS server 18) which provides SNS analysis information to the one or more user equipment 16. For example, in the case that a theme of a corresponding multimedia content is related to “North Korea's nuclear test,” related keywords 714 may include “nuclear weapons,” “plenary sessions,” “unified progressive party (UPP)”, “voting,” “national assembly,” “government,” “United States,” “UPP,” “detection,” and “xenon.” As shown in FIG. 8D, the related keywords 714 may be arranged according to the number of citations of each related keyword. When a user selects a specific keyword (e.g., “nuclear weapons”) of the related keywords 714 through a user interface, a corresponding user equipment may send a request for SNS analysis information and corresponding SNS messages associated with the selected related keyword (e.g., “nuclear weapons”), to the server (e.g., content providing server 10, social analysis server 12, or SNS server 18). As shown in “830” of FIG. 8D, when receiving the request from the user equipment, the server may provide the SNS analysis information and a portion or all of the corresponding SNS messages (e.g., SNS messages including the keyword “nuclear weapons”) to the user equipment. In this case, the user equipment may display the received SNS analysis information and SNS messages (e.g., 830). Herein, the SNS analysis information associated with the selected related keyword (e.g., “nuclear weapons”) may include the total number of SNS messages including the selected related keyword (e.g., “nuclear weapons”), and negative/positive response proportions of the corresponding SNS messages. Furthermore, a negative/positive response analysis result of each related keyword may be visually expressed. More specifically, colors of rectangular border lines and/or corresponding related keywords may differ according to a proportion of negative/positive responses associated with the corresponding related keywords. For example, in case of the related keyword “nuclear weapons,” a proportion (e.g., 57.14%) of negative responses is greater than a proportion (e.g., 42.86%) of positive responses. In this case, colors of the rectangular border line 831 and/or the keyword “nuclear weapons” may be expressed in red. Accordingly, users may quickly and easily recognize response types associated with each related keyword. In other embodiments, a variety of visual expression means (e.g., size, fonts, shapes. etc.) may be employed for presentation of positive/negative response analysis results.

As described in FIG. 2 and FIG. 3, a user may selectively display only specific analysis information on a screen of user equipment, by using a display control function associated with a display of SNS analysis information. Since such selective control function was already described with reference to FIG. 2 and FIG. 3, the detailed description thereof is omitted.

The present embodiment may classify SNS users into active SNS users and non-active SNS users based on an SNS activity amount, and differently determine a social analysis period (i.e., an SNS data collection period) according to SNS user types. In particular, a social analysis period (e.g., the unit of minutes) for the active SNS users may be shorter than a social analysis period (e.g., the unit of hours or days) for the non-active SNS users. Accordingly, the present embodiment may provide an real-time SNS data analysis result along with a multimedia content to users, thereby inducing users' interest in a corresponding multimedia content providing service (e.g., a content broadcast service).

Furthermore, the present embodiment may provide an real-time SNS data analysis result to a corresponding multimedia content provider, thereby enabling the corresponding multimedia content provider to quickly grasp users' opinions (or public opinion). In this case, the multimedia content provider may provide a new business model through an establishment of a fee-based service model of a multimedia content providing service (e.g., a live broadcast service).

Meanwhile, in at least one embodiment, methods of performing an SNS data analysis, and/or methods of providing multimedia contents using an SNS data analysis may be embodied in the form of a computer-readable recording medium (e.g., a non-transitory computer-readable recording medium) storing a computer executable program that, when executed, causes a computer to perform the method(s).

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of performing a social analysis for a multimedia content service, the method comprising:
classifying social network service (SNS) users into active SNS users and non-active SNS users based on an SNS activity amount;
collecting SNS data created by the active SNS users in a preset analysis time range; and
creating SNS analysis information associated with a specific multimedia content by analyzing the collected SNS data.

2. The method of claim 1, further comprising:
transmitting the SNS analysis information to at least one of a corresponding content providing server and one or more corresponding user equipment.

3. The method of claim 1, wherein the active SNS users and non-active SNS users are classified based on whether the number of SNS use is greater than or equal to one within one week.

4. The method of claim 1, wherein the collecting includes:
collecting the SNS data created by the active SNS users, at a first time interval.

5. The method of claim 4, further comprising:
collecting SNS data created by the non-active users, at a second time interval, wherein the second time interval is longer than the first time interval.

6. The method of claim 5, wherein:
the preset analysis time range is a time range from a broadcast start time to a broadcast end time, in a case that the specific multimedia content is a live broadcast content;
the first time interval is determined in a unit of minutes; and
the second time interval is determined in a unit of hours or days.

7. The method of claim 1, wherein the creating includes:
extracting SNS data including one or more keywords associated with a specific multimedia content, from the collected SNS data; and
creating the SNS analysis information by analyzing attributes of the extracted SNS data.

8. The method of claim 7, wherein the one or more keywords are received from a corresponding content providing server.

9. The method of claim 7, wherein the SNS analysis information includes at least one of (i) an SNS data amount per time slot, (ii) a proportion of positive/negative responses, (iii) a proportion of posted/re-posted SNS data, and (iv) one or more related keywords.

10. The method of claim 9, wherein the SNS analysis information includes statistical information expressed using one or more visual expression means.

11. The method of claim 9, wherein the SNS analysis information is mapped to the collected SNS data.

12. The method of claim 9, wherein the SNS analysis information includes:
a first layout including one or more icons and basic SNS analysis information to be provided through the one or more icons; and
a second layout including detailed SNS analysis information and corresponding SNS data, wherein the second layout is provided in response to a user request.

13. The method of claim 7, wherein, in a case that the specific multimedia content includes a plurality of themes,
the one or more keywords associated with the specific multimedia content are separately determined per each theme of the specific multimedia content.

14. A method of providing social network service (SNS) analysis information in a content providing server, the method comprising:
transmitting one or more keywords associated with a multimedia content, to a social analysis system;
providing a multimedia content service to one or more user equipment;
receiving the SNS analysis information from the social analysis system; and
providing the SNS data information to the one or more user equipment.

15. The method of claim 14, wherein the social analysis system is configured to:
classify SNS users into active SNS users and non-active SNS users based on an SNS activity amount;
receive the one or more keywords from the content providing server;
collect SNS data created by the active SNS user;
extract SNS data including the one or more keywords, from the collected SNS data;
create the SNS analysis information associated with the multimedia content by analyzing the extracted SNS data; and
transmit the SNS analysis information to the content providing server.

16. The method of claim 15, wherein the social analysis system is configured to:
collect the SNS data created by the active SNS users, at a first time interval; and
collect SNS data created by the non-active users, at a second time interval being longer than the first time interval.

17. The method of claim 16, wherein:
the first time interval is determined in a unit of minutes; and
the second time interval is determined in a unit of hours or days.

18. The method of claim 14, wherein:
the multimedia content service is a live broadcast service; and
the SNS data information is provided along with the live broadcast service.

19. A method of displaying social network service (SNS) analysis information in user equipment, the method comprising:
receiving a multimedia content from a content providing server;
receiving the SNS analysis information associated with the multimedia content, from at least one of the content providing server and a social analysis system; and
displaying the multimedia content and the SNS analysis information,
wherein the SNS analysis information includes:
a first layout including one or more icons and basic SNS analysis information provided through the one or more icons; and
a second layout including detailed SNS analysis information and corresponding SNS data, wherein the second layout is displayed according to a user selection.

20. The method of claim 19, wherein:
the multimedia content is a live broadcast content; and
the SNS analysis information includes statistical information expressed using one or more visual expression means.
